(19) United States
(12) Patent Application Publication
(10) Pub. No.: US 2023/0063686 A1
(43) Pub. Date: Mar. 2, 2023

(54) FINE-GRAINED STOCHASTIC NEURAL ARCHITECTURE SEARCH

(71) Applicant: Google LLC, Mountain View, CA (US)

(72) Inventors: Hanhan Li, Fremont, CA (US); Max Moroz, Sunnyvale, CA (US); Shraman Ray Chaudhuri, Sunnyvale, CA (US); Yair Alon, Mountain View, CA (US); Elad Eban, Sunnyvale, CA (US)

(21) Appl. No.: 17/797,996

(22) PCT Filed: Feb. 8, 2021
(86) PCT No.: PCT/US2021/017128

§ 371 Date: Aug. 5, 2022

Related U.S. Application Data
(60) Provisional application No. 62/971,866, filed on Feb. 7, 2020.

(51) Int. Cl. G06N 3/08; G06K 9/62

(52) U.S. Cl. CPC G06N 3/08; G06K 9/6262

(57) ABSTRACT

Methods, systems, and apparatus, including computer programs encoded on computer storage media, for determining neural network architectures. One of the methods includes receiving training data; receiving architecture data; assigning, to each of a plurality of network operators, a utilization variable indicating a likelihood of the network operator being utilized in a neural network; generating an optimized neural network for performing the neural network task, comprising, repeatedly performing the following: sampling a selected set of network operators; and training the neural network having an architecture defined by the selected set of network operators, wherein the training comprises: computing an objective function evaluating (i) a measure of computational cost of the neural network and (ii) a measure of performance of the neural network on the neural network task associated with the training data; and adjusting the respective current values of the utilization variables and respective current values of the neural network parameters.

### CROSS-REFERENCE TO RELATED APPLICATION

This application claims priority to U.S. Provisional Application No. 62/971,866 filed on Feb. 7, 2020. The disclosure of the prior application is considered part of and is incorporated by reference in the disclosure of this application.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a neural network architecture optimization system implemented as computer programs on one or more computers in one or more locations that determines an optimal network architecture for a neural network configured to perform a particular machine learning task. Depending on the task, the neural network can be configured to receive any kind of digital data input and to generate any kind of score, classification, or regression output based on the input.

In general, one innovative aspect of the subject matter described in this specification can be embodied in a method comprising: receiving training data for training a neural network to perform a neural network task, the training data comprising a plurality of training examples and a respective target output for each of the training examples; receiving architecture data defining a plurality of network operators; assigning, to each of the plurality of network operators, a utilization variable indicating a likelihood of the network operator being utilized in a neural network; generating an optimized neural network for performing the neural network task, comprising, repeatedly performing the following: sampling, from the plurality of network operators and in accordance with respective current values of the utilization variables, a selected set of network operators; and training the neural network having an architecture defined by the selected set of network operators on the training data to perform the neural network task, wherein the training comprises: computing an objective function evaluating (i) a measure of computational cost of the neural network and (ii) a measure of performance of the neural network on the neural network task associated with the training data; and adjusting, based on a determined gradient of the objective function, the respective current values of the utilization variables and respective current values of the neural network parameters.

The architecture data may be initialized from one or more predetermined neural network architectures. The method may further comprise removing redundant network operators from the plurality of network operators. The plurality of operators may comprise neural network layers. The neural network layers may comprise at least one of convolutional layers, fully connected layers, normalization layers, or activation layers. The plurality of operators may further comprise filters in convolutional layers, or neurons in fully connected layers. The measure of computational cost of the neural network may comprise at least one of a size, a floating point operations per second (FLOPS), or a latency. Generating the optimized neural network for performing the neural network task may further comprise: inserting a zero-masking layer after each operator that is not one of the selected set of network operators. Generating the optimized neural network for performing the neural network task may further comprise: combining respective outputs of the selected set of network operations using concat aggregators. Each utilization variable may be defined by one or more distribution parameters. The method may further comprise computing the determined gradient of the objective function with respect to the one or more distribution parameters. Adjusting the respective values of the utilization variables may comprise: backpropagating the determined gradient of the objective function through the utilization variables into the one or more distribution parameters. The one or more distribution parameters may define a Binary Concrete distribution.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages.

The described techniques allow for a neural network architecture optimization system to effectively and automatically determine a neural network architecture from a search space that will result in a small-size (i.e., parameter-efficient) and yet high-performing neural network for a particular task. Specifically, during the search process, the system makes use of trainable, stochastic masks to encourage sparsity in candidate neural network architectures, thereby reducing runtime latency, memory footprint, or both of a neural network having the resulting architecture. Specialized hardware can be optimized to perform sparse operations efficiently and with minimal runtime latency, e.g., by not computing multiplications that involve a 0. Sparse matrices can be stored efficiently in memory, i.e., by not explicitly storing the values that are 0, reducing the memory footprint of the resulting architecture.

The described techniques further allow the system to jointly determine trained parameter values of a neural network having the selected neural network architecture by training the neural network on a training dataset associated with the particular task. More importantly, the particular task can be any neural network task and the search space can be initialized from any existing neural network architectures. As such, the system can automatically generate resultant trained neural networks that are able to achieve performance on a wide range of tasks competitive with or exceeding state-of-the-art models while having relatively smaller model sizes, thus being suitable for deployment on hardware platforms with limited computational resources, including, for example, mobile devices and embedded systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system.

FIG. 2 is a flow diagram of an example process for searching for an architecture for a neural network.

FIG. 3 is a flow diagram of an example process for training a neural network having an architecture defined by a selected set of network operators.

FIG. 4A-B show example illustrations of search spaces.

FIG. 5 shows an example illustration of inserting masks that correspond to utilization variables to network operators.

Like reference numbers and designations in the various drawings indicate like elements.

### DETAILED DESCRIPTION

This specification describes a system implemented as computer programs on one or more computers in one or more locations that determines an architecture for a task neural network that is configured to perform a particular neural network task.

The neural network can be trained to perform any kind of machine learning task, i.e., can be configured to receive any kind of digital data input and to generate any kind of score, classification, or regression output based on the input.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

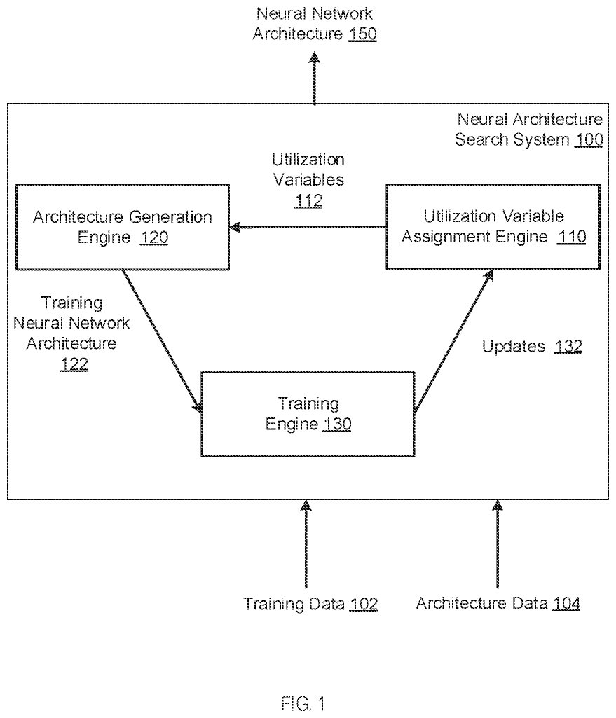

FIG. 1 shows an example neural architecture search system 100. The neural architecture search system 100 is an example of a system implemented as computer programs on one or more computers in one or more locations, in which the systems, components, and techniques described below can be implemented.

The neural architecture search system 100 is a system that obtains training data 102 for training a neural network to perform a machine learning task and architecture data 104 defining a plurality of network operators and uses the training data 102 and the architecture data 104 to determine an optimal neural network architecture for performing the machine learning task and to train a neural network having the optimal neural network architecture to determine trained values of parameters of the neural network.

The training data 102 can include multiple training examples and a respective target output for each training example. The target output for a given training example is the output that should be generated by the trained neural network by processing the given training example. In some implementations, the system 100 divides, e.g., randomly partitions, the received training data 102 into a training subset, a validation subset, and, optionally, a test subset.

The CIFAR-10 dataset, which consists of 60000 training examples paired with a target output classification selected from ten possible classes, is an example of such training data. CIFAR-1000 is a related dataset where the classification is one of 1000 possible classes. Another example of suitable training data is the ImageNet dataset, which consists of more than 14 million images paired with a target output classification selected from more than 20000 possible classes. Some or all of these images are also paired with bounding box data that specify the boundaries of the regions in which an object belonging to one of the possible classes is present.

The architecture of a neural network generally defines the number of layers in the neural network, the operations performed by each of the layers, and the connectivity between the layers in the neural network, i.e., which layers receive inputs from which other layers in the neural network.

In some implementations, the architecture data 104 includes data specifying a set of candidate neural network architecture components. Each candidate architecture component can be in the form of a neural network cell or a neural network block. An architecture of a neural network generated by the system 100 from the architecture data 104, e.g., a training architecture 122 generated during the search process or a final architecture 150 generated at the end of the search process, can be in form of a tower. A tower is a neural network that includes a sequence of neural network cells, a sequence of neural network blocks, or both, with each cell (or block) after the first cell (or block) in the sequence receiving input from one or more cells (or blocks) that are earlier in the sequence, receiving the network input, or both. For example, each cell can be made up of multiple blocks, with each block receiving input from one or more preceding cells and one or more preceding blocks within the same cell.

In some such implementations, the architecture generated by the system 100 from the architecture data 104 can have a plurality of neural network cells, where each cell can have a plurality of neural network blocks, and where each block can be a directed graph for arranging multiple neural network layers. Each neural network layer in the block can be configured to receive an input tensor from a previous layer and to generate, for the input tensor, an output tensor to be fed as input to the next neural network layer. The plurality of neural network layers included in each block can be of different types, i.e., can perform different types of operation on different size input tensor to generate different size output tensor.

While different architectures can include different numbers of cells (or blocks), the sequence of cells (or blocks) in any given candidate includes at least one and at most a fixed, maximum number of cells (or blocks). In addition to the sequence of one or more neural network cells or blocks, each tower can optionally include one or more pre-determined components, e.g., one or more input layers before the first block in the sequence, one or more intermediate, pooling layers, one or more output layers after the last block in the sequence, or a combination thereof.

In some implementations, the architecture data 104 can be initialized or otherwise derived from one or more baseline network architectures or search spaces. Examples of such baseline network architectures or search spaces are described in more details at Gabriel Bender et al. Understanding and simplifying one-shot architecture search. In International Conference on Machine Learning, pages 549-558, 2018, Bichen Wu et al. Fbnet: Hardware-aware efficient convnet design via differentiable neural architecture search. In Proceedings of the IEEE Conference on Computer Vision and Pattern Recognition, pages 10734-10742, 2019, and Ariel Gordon et al. Morphnet: Fast & simple resource-constrained structure learning of deep networks. In Proceedings of the IEEE Conference on Computer Vision and Pattern Recognition, pages 1586-1595,2018.

In any of the above implementations, the architecture data 104 includes data that defines a plurality of network operators that are each configured to receive an operator input and to generate a corresponding operator output based on processing the operator input in accordance with current values of parameters associated with the network operators. For example, the operators can be neural network layers. For example, each operator can be a convolutional layer, a fully connected layer, a normalization layer, a pooling layer, or an activation layer, that applies a series of operations (e.g., transformations) to the layers inputs to generate the layer outputs. As another example, the operators can be components of the neural network layers. For example, each operator can be a filter in a convolutional layer, or a neuron in a fully connected layer. As yet another example, the operators can be combinations of two or more neural network layers, or combinations of two or more neural network layer components as described above.

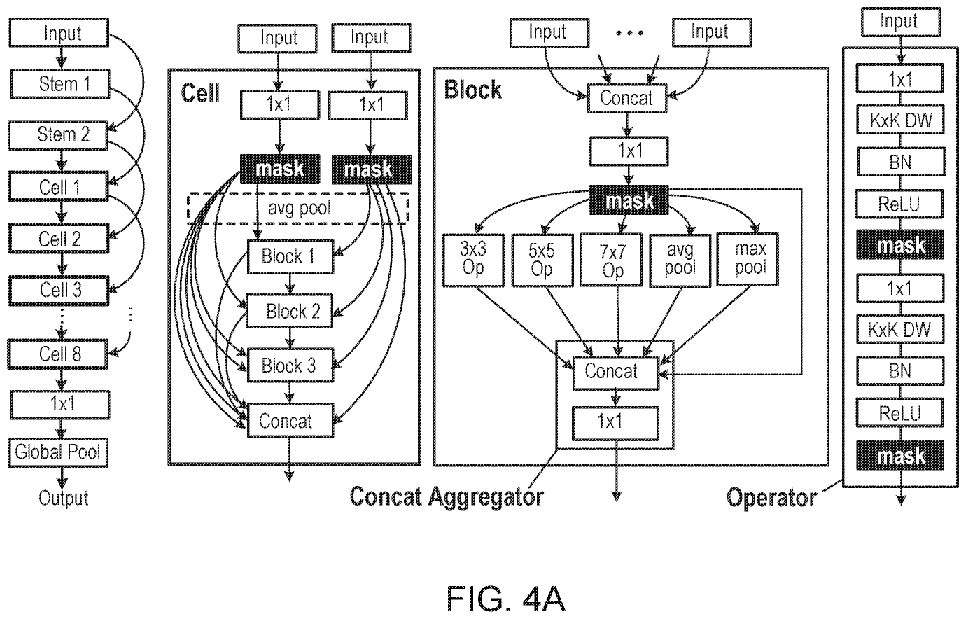

FIG. 4A shows an example illustration of a search space. The example search space includes multiple neural network cells, which in turn includes multiple neural network blocks, which in turn includes multiple operators. Each operator includes multiple neural network layers including one or more of: a 1×1 convolutional layer (“1×1”) which effectively acts as a concatenation aggregator, a k×k depthwise convolutional layer (“k×k DW”), a batch normalization layer (“BN”), and a rectified linear units activation layer (“ReLU”). An example architecture generated from the search space (as depicted on the left hand side of FIG. 4A) can be in form of a tower that includes a sequence of neural network cells, with each cell after the first cell in the sequence receiving input from one or more cells that are earlier in the sequence, receiving the network input, or both.

FIG. 4B shows an example illustration of another search space. The example search space includes multiple neural network blocks, which in turn includes multiple operators. Each operator includes multiple neural network layers including one or more of: a 1×1 convolutional layer (“1×1”) which effectively acts as a concatenation aggregator, a 3×3 depthwise convolutional layer (“3×3 DW”), a 5×5 depthwise convolutional layer (“5×5 DW”), a batch normalization layer (“BN”), and a rectified linear units activation layer (“ReLU”). The dashed line denotes an additive skip connection between different operators included in a same block. An example architecture generated from the search space (as depicted on the left hand side of FIG. 4B) can be in form of a tower that includes a sequence of neural network blocks, with each block after the first block in the sequence receiving input from a block that is earlier in the sequence.

In some implementations, the neural architecture search system 100 can additionally receive as input data that specifies one or more predetermined, e.g., user-specified, resource constraints that identify how many computational resources can be consumed by the neural network when performing inference. For example, the resource constraint may specify a target amount of computational resources used by the neural network having a final architecture. The target resource usage data specifies (i) a target memory size that indicates the maximum memory size allowed for creating the final architecture, i.e., the maximum memory that can be taken up by parameters and architecture data of the final architecture, and (ii) a target number of operations (e.g. floating point operations per second (FLOPS)) that indicates the maximum number of operations that the neural network having the final architecture can execute to perform the particular machine learning task. As another example, the resource constraint may specify a target runtime latency of the neural network when performing the task and when deployed on the one or more computing devices. Accordingly, the outputs of the neural architecture search system 100 may be further associated with the specific technical details of the hardware on which the neural network is intended to operate.

The neural architecture search system 100 can receive the training data 102, the architecture data 104, the additional input data, or a combination thereof in any of a variety of ways. For example, the system 100 can receive the data as an upload from a remote user of the system over a data communication network, e.g., using an application programming interface (API) made available by the system 100. As another example, the system 100 can receive an input from a user specifying which data that is already maintained by the system 100 should be used as the training data 102 and the architecture data 104.

To determine the final architecture, the neural architecture search system 100 repeatedly performs a search process using a utilization variable assignment engine 110, an architecture generation engine 120, and a training engine 130.

The utilization variable assignment engine 110 can assign a utilization variable 112 to each of the plurality of network operators defined in the architecture data 104. Each utilization variable 112 is associated with a value that indicates a likelihood of the network operator being utilized in the final architecture of the neural network.

The utilization variable assignment engine 110 can determine an associated value of each utilization variable 112 in accordance with a respective probability which can be parameterized by one or more tunable parameters maintained by the engine 110 (“distribution parameters”). For example, the variable assignment engine 110 can model the utilization variable as a Bernoulli random variable with continuous relaxation. A Bernoulli random variable without continuous relaxation refers to a discrete variable the value of which is either 1 with probability p or 0 with probability 1-p, and continuous relaxation techniques are described further below. For each network operator, the assigned utilization variable 112 modeled in this manner can effectively be treated as a binary mask, for example including the network operator in the architecture when the value is 1 and pruning it from the architecture when the value is 0.

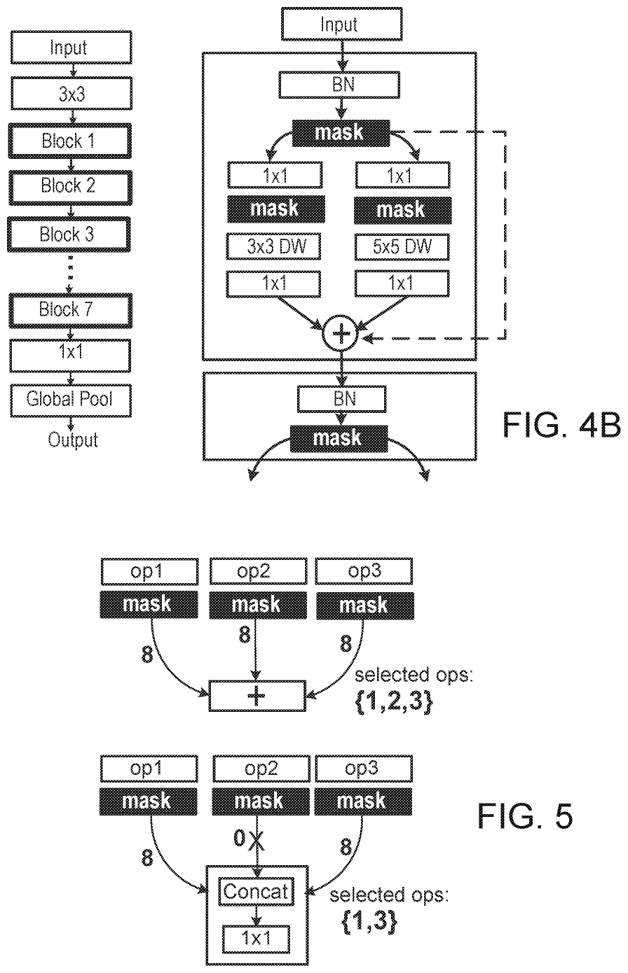

FIG. 5 shows an example illustration of inserting masks that correspond to utilization variables to network operators. As depicted, a binary masking layer that corresponds to a utilization variable assigned to the network operator (e.g., “op 1” on the top) is inserted after the network operator in the architecture. Numbers next to edges indicate the number of non-zero channels in the masking layer.

A network operator (e.g., “op 2” on the bottom) may be deselected, i.e., pruned from the current architecture, in response to sampling an all-zero masking layer inserted after the network operator. As such, deselecting a network operator is equivalent to inserting a zero-masking layer after the operator that is not in the selected set of network operators.

A portion of the components of a network operator (e.g., “op 3” on the bottom) may be deselected in response to sampling a masking layer with some but not all zero channels inserted after the network operator. As depicted on the bottom of FIG. 5, if the network operators are components of a convolutional neural network layer, i.e., filters of the convolutional neural network layer, then 5 out of the total of 8 filters of a convolutional neural network layer can be deselected in response to sampling a masking layer with 5 zero channels. This is equivalent to modifying the width of the convolutional neural network layer.

Thus, the neural architecture search system 100 can operate on any of a variety of search spaces by using the utilization variable assignment engine 110 to assign utilization variables to different network operators, i.e., to insert masks to different neural network layers as well as to different components of the neural network layer. This facilitates fine-grained search over a larger space of architectures by the system 100.

In particular, the system 100 can model the space of probability values for the utilization variables as a continuous space, and the utilization variable assignment engine 110 can model the corresponding likelihood of each network operator being utilized in the final architecture as a continuous rather than discrete likelihood. This allows for fine-grained control of the search process by the system. For example, the neural architecture search system 100 uses the utilization variable assignment engine 110 to assign, to each network operator, a utilization variable having a given numeric value (e.g., one) in accordance with a probability that is determined from a continuous distribution, e.g., a Logistic-Sigmoid distribution or a concrete distribution, over a set of probability values for the utilization variable that range from 0 to 1, inclusive on both ends.

The architecture generation engine 120 can generate, based on the value of the utilization variable 112 assigned to each of the plurality of network operators, a training candidate architecture 122 of a neural network. To generate the new training candidate architecture 122 at the beginning of the search process (or to update the existing training candidate architecture 122 during the search process), the architecture generation engine 120 can select, from the plurality of network operators defined by the architecture data 104 and in accordance with current values of the utilization variables assigned to the plurality of network operators, a selected set of network operators. For example, the architecture generation engine 120 can select network operators that have been assigned with utilization variables having values that fall within a specific range, e.g., greater than 0.9, e.g., equal to 1. The training neural network architecture 122 can then be determined by using the engine 120 as a combination of the selected set network operators. For example, the architecture generation engine 120 can do this by making use of additive aggregators that is configurable to combine fixed shape operator outputs, or 1×1 convolutional layers (i.e., concatenation aggregators) that is configurable to combine variable shape operator outputs.

In some implementations, during the search process the system 100 maintains, e.g., at a memory device accessible to the system 100, the set of distribution parameters used by the utilization variable assignment engine 110 to generate the utilization variables 112 and a set of parameters for the neural network. The set of parameters for the neural network in turn is composed of different subsets of parameters associated with different operators of the neural network.

For the training architecture 122 that is generated by using the architecture generation engine 120 and from the architecture data 104 and utilization variables 112, the training engine 130 trains an instance of the neural network having the training architecture 122 on the training data 102 to iteratively update the values of a set of parameters of the neural network and to additionally adjust the values of the utilization variables generated by using the utilization variable assignment engine 110. In particular, during training, the training engine 130 jointly optimizes two objectives—a computational cost objective and a task performance objective.

The computational cost objective can be derived from a user input to the system or from some default computational cost objectives relating to deploying a neural network on one or more computing devices to perform the particular machine learning task. For example, the computational cost objective can include one or more of: (i) a target memory size of the final architecture, (ii) a target floating point operations per second (FLOPS) of the neural network having the final architecture when performing the particular machine learning task, or (iii) a target runtime latency of the neural network when performing the particular machine learning task.

The task performance objective can evaluate a performance measure for the neural network as of the training iteration that measures the performance of the trained neural network on the particular machine learning task. For example, the performance measure can be the loss of the trained neural network on the validation data set or the result of some other measure of model accuracy when computed over the validation data set.

The training engine 130 determines the update by computing a gradient of an objective function evaluating both aforementioned objectives with respect to the network parameters. To adjust the values of distribution parameters that in turn define the utilization variable, the training engine 130 can backpropagate the determined gradient through the utilization variables into the distribution parameters.

During the search process, the system 100 can repeatedly use the architecture generation engine 120 to update the training neural network architecture 122 based on the updated values of the utilization variables assigned to each of the plurality of network operators. This allows for the system to update the training architecture of the neural network continuously and adaptively to improve the diversity of the search process. Simultaneously, the set of network parameters associated with the updated training architecture can be updated based on the gradient of the objective function computed by the training engine 130.

After the search process has terminated, e.g., after a specified number of iterations have been performed or after the gradient of the objective function has converged to a specified value, the neural network search system 100 can then output final architecture data 150 of a neural network. For example, the neural network search system 100 can output data specifying the final neural network architecture 150 to the user that submitted the training data 102. For example, the architecture data can specify the neural network operators that are part of the neural network, the connectivity between the neural network operations, and the operations performed by the neural network operators.

In some implementations, instead of or in addition to outputting the architecture data 150, the system 100 instantiates an instance of the neural network having the determined architecture and with trained parameters, e.g., either trained from scratch by the system after determining the final architecture, making use of the parameter values generated as a result of the search process, or generated by fine-tuning the parameter values generated as a result of the search process, and then uses the trained neural network to process requests received by users, e.g., through the API provided by the system. That is, the system 100 can receive inputs to be processed, use the trained neural network to process the inputs, and provide the outputs generated by the trained neural network or data derived from the generated outputs in response to the received inputs.

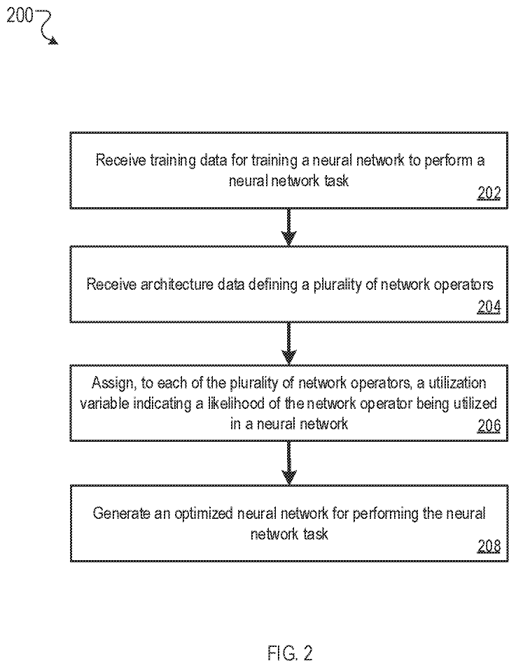

FIG. 2 is a flow diagram of an example process 200 for searching for an architecture for a neural network. For convenience, the process 200 will be described as being performed by a system of one or more computers located in one or more locations. For example, a neural architecture search system, e.g., the neural architecture search system 100 of FIG. 1, appropriately programmed, can perform the process 200.

The system receives training data for training a neural network to perform a neural network task (202). The training data includes a plurality of training examples and, for each training example, a respective target output that should be generated by the neural network to perform the particular task.

The system receives architecture data defining a plurality of network operators (204). Generally, when utilized as part of an architecture of a neural network, each network operator is configured to receive an operator input and to generate a corresponding operator output based on processing the operator input in accordance with current values of parameters associated with the network operator. For example, the operators can include neural network layers, components of a neural network layer, or combinations of two or more neural network layers, or combinations of two or more components of a neural network layer.

The system assigns, to each of the plurality of network operators, a utilization variable indicating a likelihood of the network operator being utilized in a neural network (206). The value associated with the utilization variable can be determined in accordance with a respective probability which can in turn be parameterized by one or more distribution parameters. For example, the utilization variable can be modeled as a Bernoulli random variable with continuous relaxation using a continuous probability distribution, e.g., a Logistic-Sigmoid distribution or a concrete distribution.

The system generates a neural network for performing the neural network task (208) by repeatedly performing the following two steps to jointly update the current values of the utilization variables and the current values of the parameters of the neural network: (i) sampling, from the plurality of network operators and in accordance with respective current values of the utilization variables, a selected set of network operators, and (ii) training the neural network having an architecture defined by the selected set of network operators on the training data to perform the neural network task, as described in more detail below.

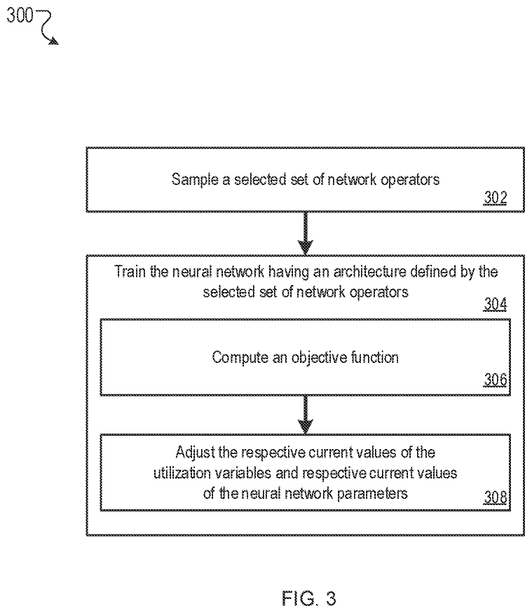

FIG. 3 is a flow diagram of an example process 300 for training a neural network having an architecture defined by a selected set of network operators. For convenience, the process 300 will be described as being performed by a system of one or more computers located in one or more locations. For example, a neural architecture search system, e.g., the neural architecture search system 100 of FIG. 1, appropriately programmed, can perform the process 300.

In general, the system can repeatedly perform the process 300 to generate a neural network having an optimal architecture for performing the neural network task.

The system samples, from the plurality of network operators and in accordance with respective current values of the utilization variables, a selected set of network operators (302).

The system trains the neural network having an architecture defined by the selected set of network operators on the training data to perform the neural network task (304). Sampling the selected set of network operators and generating the neural network having the architecture defined by the selected set of network operators is described in more detail above with reference to FIG. 1 but, in brief, this involves generating a combination of network operators that have been assigned with utilization variables having current values that fall within a specific range, e.g., equal to 1, using suitable aggregators, e.g., additive aggregators or concatenation aggregators.

During training, the system jointly updates the current values of the utilization variables and current values of the neural network parameters to optimize an objective function that evaluates both the measure of computational cost of the neural network and the measure of performance of the neural network on the neural network task associated with the training data.

To do this, the system computes an objective function (306) evaluating (i) the measure of computational cost of the neural network and (ii) the measure of performance of the neural network on the neural network task associated with the training data.

For example, the objective function can be evaluated in the form of

$${min}_{π , w} \{ {𝔼}_{m} [ {ℒ}^{t} ( w ⊙ m ) + {λℒ}^{c} ( m ) ] \} ,$$

where [symbol] ^{t} is the loss term measuring task performance objective, [symbol] ^{c} is the loss term measuing computational cost objectives, λ is the regularization factor used to scale [symbol] _{c} differently depending on the exact types of computational cost objectives of interest (e.g., FLOPS), and ⊙ denotes element-wise product between a set of one or more parameters w of the neural network having the training architecture and a binary mask m that corresponds to a utilization variable.

In this example, [symbol] ^{t} can be a supervised loss used in conventional machine learning training on the task, that is, the loss of the training outputs determined with respect to associated target outputs included in the training data, where the training outputs are generated by the neural network from processing the training examples in accordance current values of the network parameters.

And [symbol] ^{c} can be evaluated in the form of

$$𝔼 [ {ℒ}_{i}^{c} ] \approx {π}_{i} \cdot ( {\sum }_{j} {π}_{j}^{{A}_{in}} + {\sum }_{k} {π}_{k}^{{B}_{out}} ) ,$$

where \dot{m}ⱼ^{A}^{ᵢₙ} and \dot{m}ₖ^{B}^{ₒᵤₜ} denote per-channel binary masks applied on inputs to matrix A and on outputs of matrix B, respectively, and π denotes the distribution parameters. Matrix A (or

B) can be a weight matrix representing values of the parameters associated with a network operator, e.g., a convolutional layer or a fully-connected layer of the neural network.

The system adjusts, based on a determined gradient of the objective function, the current values of the utilization variables and current values of the neural network parameters (308). The system can do this by computing the gradient of the objective function with respect to parameters of the neural network and then backpropagating the determined gradient of the objective function through the utilization variables into the one or more distribution parameters.

In some cases, mᵢ can be modeled as independent Bernoulli variables mᵢ˜Bern(πᵢ), and the system can determine an estimate the gradient with respect to the distribution parameters π using black-box methods, e.g., perturbation or log-derivative methods.

In other cases, mᵢ can instead be modeled as a continuous sample from a Logistic-Sigmoid distribution

$${\hat{m}}_{i} = Sigmoid ( ( log ( \frac{{π}_{i}}{1 - {π}_{i}} ) + ℓ ) / τ ) ,$$

where [symbol] ˜Logistic (0,1), and as τ→0, \hat{m}ᵢ approaches (0, 1) with probability (1−πᵢ, πᵢ), respectively. Factoring out the logistic term as a parameter-free component allows the system to backpropagate the computed gradient of the objective function through the mask and learn values of the distribution parameters π using conventional parameter update techniques such as gradient descent-based techniques.

The system can then use an appropriate update rule, e.g., a stochastic gradient descent update rule, an Adam update rule, an rmsProp update rule, to apply the gradient to adjust utilization variables and the network parameters.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving training data for training a neural network to perform a neural network task, the training data comprising a plurality of training examples and a respective target output for each of the training examples;
receiving architecture data defining a plurality of network operators;
assigning, to each of the plurality of network operators, a utilization variable indicating a likelihood of the network operator being utilized in a neural network;
generating an optimized neural network for performing the neural network task, comprising, repeatedly performing the following:
sampling, from the plurality of network operators and in accordance with respective current values of the utilization variables, a selected set of network operators; and
training the neural network having an architecture defined by the selected set of network operators on the training data to perform the neural network task, wherein the training comprises:
computing an objective function evaluating (i) a measure of computational cost of the neural network and (ii) a measure of performance of the neural network on the neural network task associated with the training data; and
adjusting, based on a determined gradient of the objective function, the respective current values of the utilization variables and respective current values of the neural network parameters.

2. The method of claim 1, wherein the architecture data is initialized from one or more predetermined neural network architectures.

3. The method of claim 1, further comprising:
removing redundant network operators from the plurality of network operators.

4. The method of claim 1, wherein the plurality of operators comprises neural network layers.

5. The method of claim 4, wherein the neural network layers comprises at least one of convolutional layers, fully connected layers, normalization layers, or activation layers.

6. The method of claim 5, wherein the plurality of operators further comprises filters in convolutional layers, or neurons in fully connected layers.

7. The method of claim 1, wherein the measure of computational cost of the neural network comprises at least one of a size, a floating point operations per second (FLOPS), or a latency.

8. The method of claim 1, wherein generating the optimized neural network for performing the neural network task further comprises:
inserting a zero-masking layer after each operator that is not one of the selected set of network operators.

9. The method of claim 1, wherein generating the optimized neural network for performing the neural network task further comprises:
combining respective outputs of the selected set of network operations using concat aggregators.

10. The method of claim 1, wherein each utilization variable is defined by one or more distribution parameters.

11. The method of claim 10, further comprising:
computing the determined gradient of the objective function with respect to the one or more distribution parameters.

12. The method of claim 10, wherein adjusting the respective values of the utilization variables comprises:
backpropagating the determined gradient of the objective function through the utilization variables into the one or more distribution parameters.

13. The method of claim 10, wherein the one or more distribution parameters define a Binary Concrete distribution.

14. A system comprising one or more computers and one or more storage devices storing instructions that are operable, when executed by the one or more computers, to cause the one or more computers to perfortm the operations comprsing:
receiving training data for training a neurai network to perform a neural network task, the training data comprising a plurality of training exaples and a respective target output for each of the training examples:
receiving architecture data defining a plurality of network operators:
assigning, to each of the plurality of network operators, a utilization variable indicating a likelihood of the network operator being utilized in a neural network;
generating an optimized neural network for performing the neural network task, comprising, repeatedly performing the following:
sampling, from the plurality of network operators and in accordance with respective current values of the utilization variables, a selected set of network operators: and
training the neural network having an architecture defined by the selected set of network operators on the training data to perforin the neural network task, wherein the training comprises:
computing an objective function evaluating (i) a measure of computational cost of the neural network and (ii) a measure of performance of the neural network on the neural network task associated with the training data; and
adjusting, based on a determined gradient of the objective function, the respective current values of the utilization variables and respective current values of the neural network parameters.

15. A computer storage medium encoded with instructions that, when executed by one or more computers, cause the one or more computers to perform the operations comprising:
receiving training data for training a neural network to perform a neural network task, the training data comprising a plurality of training examples and a respective target output for each of the training examples:
receiving architecture data defining a plurality of network operators;
assigning, to each of the plurality of network operators, a utilization variable indicating a likelihood of the network operator being utilized in a neural network;
generating an optimized neural network for performing the neural network task, comprising, repeatedly performing the following:
sampling, from the plurality of network operators and in accordance with respective current values of the utilization variables a selected set of network operators; and
training the neural network having an architecture defined bv the selected set of network operators on the training data to perform the neural network task, wherein the training comprises:
computing an objective function evaluating (i) a measure of computational cost of the neural network and (ii) a measure of performance of the neural network on the neural network task associated with the training data; and
adjusting, based on a determined gradient of the objective function, the respective current values of the utilization variables and respective current values of the neural network parameters.

16. The system of claim 14, wherein the architecture data is initialized from one or more predetermined neural network architectures.

17. The system of claim 14, wherein the operations further comprise:
removing redundant network operators from the plurality of network operators.

18. The system of claim 14, wherein the plurality of operators comprises neural network layers.

19. The system of claim 18, wherein the neural network layers comprises at least one of convolutional layers, fully connected layers, normalization layers, or activation layers.

20. The system of claim 19, wherein the plurality of operators further comprises filters in convolutional layers, or neurons in fully connected layers.
